(19) United States
(12) Patent Application Publication
(10) Pub. No.: US 2004/0177316 A1
(43) Pub. Date: Sep. 9, 2004

(54) Page composition

(76) Inventors: Paul Layzell, Glos (GB); Eldan Goldenberg, Cleveland, OH (US); David Trevor Cliff, Southville (GB); John William Lumley, Bristol (GB)

Correspondence Address: HEWLETT-PACKARD COMPANY, Intellectual Property Administration, P.O. Box 272400, Fort Collins, CO, 80527-2400, US

(21) Appl. No.: 10/652,787

(22) Filed: Aug. 29, 2003

(30) Foreign Application Priority Data
Aug. 30, 2002 (GB) 0220166.3

(51) Int. Cl. G09G 5/00

(52) U.S. Cl. 715/500

(57) ABSTRACT

A page is composed by establishing an arrangement of objects to be fitted on to the page and then carrying out an iterative process to minimise a cost function dependent on properties of the arrangement. Computational advantages are obtained by describing such arrangements as slicing structures.

### FIELD OF THE INVENTION

This invention relates to page composition for documents, and is particularly relevant to generation of custom documents from a plurality of objects.

### DESCRIPTION OF PRIOR ART

Composition of document pages is a difficult task to achieve in a practical and aesthetically satisfactory manner. It is generally an integral part of the composition of a new document. However, it is frequently the case that a new document is to be created from, in whole or in part, a collection of pre-existing objects. This task will normally be taken by a human professional with graphic design skills. Solutions for automating this task are limited. The conventional solution is to use a template for a page, and to fit the chosen pre-existing objects into the space on a template (this approach is used, for example, in the personalised recommendation templates provided by websites such as www.amazon.com). Recently it has been suggested by Lisa Purvis in “A Genetic Algorithm Approach to Automated Custom Document Assembly”, Proceedings of the Second International Workshop on Intelligent Systems Design and Applications (ISDA 2002), August 2002, Atlanta, USA that custom document assembly from existing parts using a genetic algorithm may satisfy content and layout constraints and fulfil certain desired design properties by specification of a group of high-order constraints. Such an approach requires limited user interaction but is computationally complex.

### SUMMARY OF THE INVENTION

Accordingly, in a first aspect of the invention there is provided a method of composing a page, or a portion of a page, of a document, by a programmed processor comprising: receiving a definition of a plurality of objects to be fitted on to the page and dimensional attributes of each of the objects; establishing an arrangement of the plurality of objects such that each object lies within a separate rectangle of a slicing structure dissection of a rectangular area; preparing for evaluation for the plurality of objects a function which provides a total cost of an arrangement of the plurality of objects based on one or more properties of the arrangement; and finding a slicing structure arrangement of the plurality of objects with a minimised total cost by means of an iterative process.

It should be noted that in this context, dimensional attributes of an object need not be a height and width coordinate, but may be any aspect of the dimensions of the object necessary to allow an arrangement to be determined and a cost evaluated. For example, dimensional attributes may be an area or range of areas and an aspect ratio or range of aspect ratios.

It should also be noted that the cost of a slicing structure arrangement may be determined in a number of ways. In preferred arrangements, the cost is determined wholly or partly on total area taken up by the arrangement, but other factors directly related to packing (proximity of related elements, aspect ratio of the resulting arrangement) may contribute to the cost, as may factors which do not relate to packing (such as assessment of the aesthetic merits of the result—for example by determining that objects of interest are distributed appropriately across the page, or are located such as to lend the result “eye appeal”, for example by locating objects at golden section points).

In a second aspect of the invention there is provided a method of composing a page, or a portion of a page, of a document, by a programmed processor comprising: receiving a definition of a plurality of objects to be fitted on to the page and dimensional attributes of each of the objects; establishing, for the plurality of objects, evaluation of a function to represent a total area of an arrangement of the plurality of objects; minimising the function to find a minimised total area arrangement; and fitting the minimised total area arrangement to the page.

In a third aspect of the invention there is provided a method of providing a customised document having a plurality of pages, comprising: receiving a plurality of selected objects for inclusion in the document from a database of two-dimensional objects and an assignation of each of the selected objects to one of a plurality of groups, and an assignation of each of the selected objects to one of the pages of the document; producing a function dependent on a total area of the arrangement and on proximity to each other of objects in the same group and for said one of the pages of the document establishing, for the objects assigned to that page, evaluation of the function; arranging the objects assigned to the said one of the pages in an arrangement such as to minimise the function.

In a further aspect, the invention provides a method of composing a page, or a portion of a page, of a document, comprising: defining a plurality of objects to be fitted on to the page and dimensional attributes of each of the objects; establishing an arrangement of the plurality of objects such that each object lies within a separate rectangle of a slicing structure dissection of a rectangular area; establishing a function which provides a total cost of an arrangement of the plurality of objects based on one or more properties of the arrangement; and finding a slicing structure arrangement of the plurality of objects with a minimised total cost by means of an iterative process.

A processor of a computer system may be programmed to carry out a method according to any of these aspects. Such programming may be achieved by use of a signal or data carrier having code adapted to program the processor accordingly.

### BRIEF DESCRIPTION OF THE DRAWINGS

Specific embodiments of the invention will now be described, by way of example, with reference to the accompanying drawings, of which:

FIG. 1 shows an arrangement of objects on a page of a document;

FIG. 2 shows the dissection of a rectangle into a slicing structure as employed in embodiments of the invention;

FIG. 3 shows the slicing structure of FIG. 2 represented as a slicing tree;

FIG. 4 shows the slicing structure of FIG. 2 represented as a Polish expression;

FIG. 5 illustrates a first mutation operation used in a genetic algorithm operating on the slicing structure of FIG. 2 according to one embodiment of the invention;

FIG. 6 illustrates a second mutation operation used in a genetic algorithm operating on the slicing structure of FIG. 2 according to one embodiment of the invention;

FIG. 7 illustrates a third mutation operation used in a genetic algorithm operating on the slicing structure of FIG. 2 according to one embodiment of the invention;

FIG. 8 illustrates a first crossover operation used in a genetic algorithm operating on the slicing structure of FIG. 2 according to one embodiment of the invention;

FIG. 9 illustrates a second crossover operation used in a genetic algorithm operating on the slicing structure of FIG. 2 according to one embodiment of the invention;

FIG. 10 illustrates a third crossover operation used in a genetic algorithm operating on the slicing structure of FIG. 2 according to one embodiment of the invention;

FIG. 11 shows the third crossover operation of FIG. 10 in relation to a tree structure;

FIGS. 12A, 12B and 12C show bounding curves indicating the dimensions of rectangles into which objects of constant area and variable aspect ratio can be fitted;

FIG. 13 illustrates how the bounding curve of an expression can be derived from the bounding curves of the two operands;

FIG. 14 shows an example of a composed page according to an embodiment of the invention;

FIGS. 15A, 15B and 15C show examples of composed pages with the same set of two groups of objects composed according to an embodiment of the invention with different relative cost weightings to total area and to separation of objects in a group;

FIG. 16 represents steps involved in a process of producing a customised document to which aspects of the present invention are applicable;

FIG. 17 shows a computing system suitable for carrying out embodiments of the invention and for consuming the results thereof;

FIGS. 18A to 18E illustrate the effects of different rules for determining order or grouping of elements on a composed page;

FIG. 19 illustrates by means of a Polish expression the use of genes within a modified Polish expression for describing a slicing structure;

FIG. 20 illustrates an optimisation process useful for arrangements such as that shown in FIG. 19; and

FIG. 21A to 21C illustrates the use of a rule for determining order of elements on a composed page according to aspects of the present invention

### DETAILED DESCRIPTION OF SPECIFIC EMBODIMENTS OF THE INVENTION

A method of providing a customised document according to embodiments of the invention will now be described.

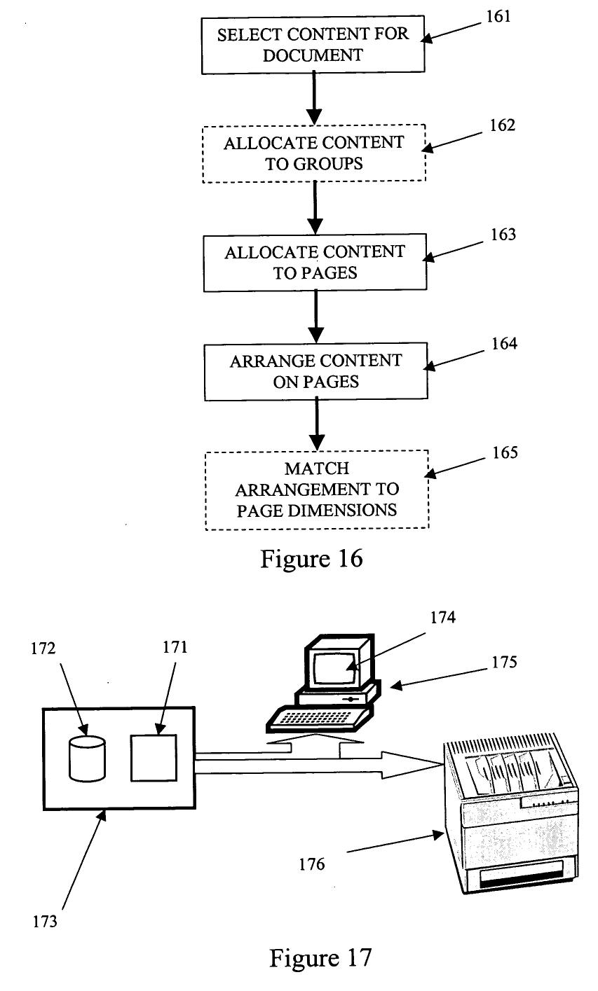

Basic steps of a document production process are shown in FIG. 16. The initial step 161 is to determine what content the document needs to contain. The document may be, for example, a brochure tailored to the interests of the intended recipient—in this example, we shall assume the case of a holiday brochure. For this stage of the process, any of a number of conventional approaches could be used both to determine the interests of the intended recipient and to make a selection of content items. One such conventional approach is outlined as follows. The content items are a collection of viewable or printable two-dimensional elements, all relating to holidays: these may be pictures of locations, text descriptions of holiday packages, text descriptions of flights and so on. Each is tagged with one or more descriptors indicating their relevance to a particular keyword. The significance of the keywords for the intended recipient is determined by direct polling of the recipient, by analysing past holiday choices made by the recipient, or by studying web pages viewed by the recipient or by some combination of some or all of these. The significance of the keywords to the intended recipient is combined with the relevance of the keywords to the content items to provide a selection score for each content item, and the content items above a threshold value are selected for inclusion. This is merely one exemplary approach among many, and it should be noted that essentially any approach for determining particularly relevant content items in a database (such as, for example, approaches used for selection of content by search engines operating on the World Wide Web) can be used in connection with aspects of the present invention.

For particular aspects of the invention, it is appropriate that the selected content items are divided into a number of groups 162. This again can be achieved in a number of ways: for example, a content item may be assigned to a group on its entry into the database, or may be assigned after selection to a group determined by a keyword to which it is most relevant.

Once selected, for a multiple page document it will be necessary to assign 163 selected content items to a page. This again can be achieved in a number of ways (according to a predetermined order of groups, in accordance with greatest interest scores for the intended recipient, or otherwise) and need not in all cases be an irrevocable assignment (it may be affected by subsequent inability to produce a satisfactory arrangement of content items, for example). Again, aspects of the present invention can be employed in accordance with essentially any strategy for allocating content items to pages. The number of pages in the document may also be determined in accordance with the number, or total size, of data items to be provided (of course, selection criteria may also be tightened or relaxed so that the amount of content matches the space available).

The next step is that of primary interest in application of aspects of the present invention—the arrangement 164 of selected content items allocated to a document page on that document page. This will be discussed in much greater detail below. In different aspects of the invention, some or all of these content items may be equivalent, may be grouped, or may be ordered. There may be additional document reorganisation steps after an arrangement has been made—particularly if it has not been possible to produce a satisfactory arrangement for the or any one of the pages, in which case it may be necessary to transfer content items from page to page, or to add further pages to the document—but the only remaining step to be generally expected is matching 165 of the arrangement to the viewable region of the page. This may involve a scaling or expansion process—again, this will be described in greater detail below.

This process can be achieved on conventional computational hardware programmed with appropriate software (provided according to aspects of the invention). An appropriate system is shown in FIG. 17. The steps of FIG. 16 may be carried out by an appropriately programmed processor 171 with access to a memory 172, for example here in server 173. The result is to be rendered on display 174 of a client computer 175, or, in cases of particular interest here, to be printed on printer 176 (which may be of essentially any type—a laser printer is shown here, though for the case of custom publishing a preferred solution may be a high performance digital printer such as the HP Indigo Press w3200).

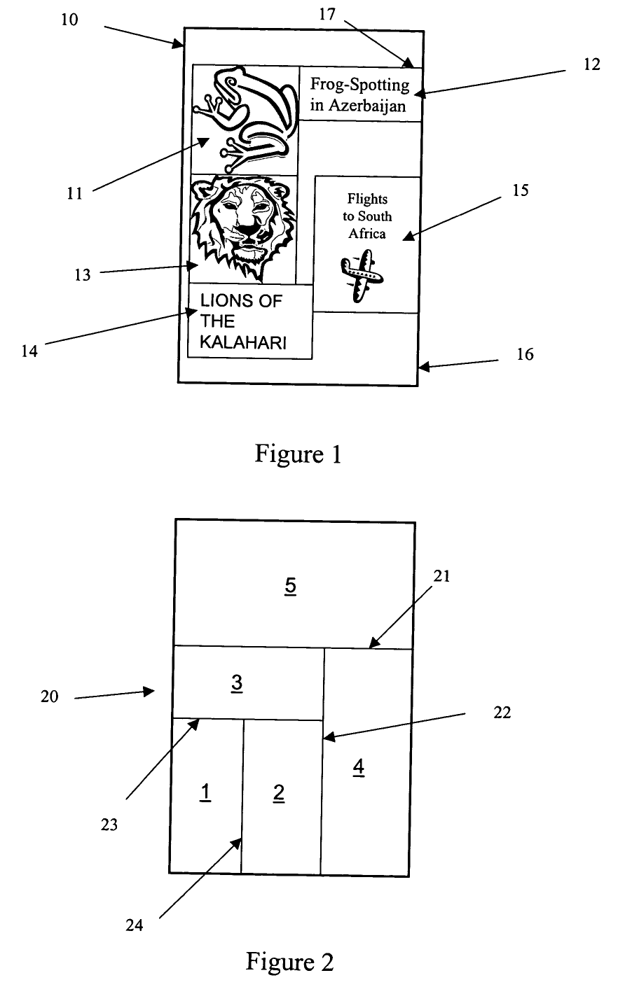

The result for a document page may be such as that shown in FIG. 1. Two content items in a group relating to “Frogs”—picture 11 and text block 12—lie together at the top of a page 10, whereas three content items in a group relating to “Lions”—picture 13, text block 14 and mixed block 15—lie together at the bottom of the page 10. Note that the border 16 of the page 10 is a visually apparent border, whereas the border 17 of a content item is not (necessarily) a visible border, but may have significance only in the process of page composition. There will now be described an approach by which a logical and visually satisfactory arrangement of content elements may be achieved in accordance with aspects of the present invention.

It can be seen that content items here are, visually, two-dimensional objects that may be fitted on to a page of a document. In certain aspects of the invention, it is appropriate to represent content items as rectangular with the same axes as for the page (if the informative content is not rectangular, the content item may have the dimensions of, for example, the smallest such rectangle that could bound the informative content).

The present inventors have appreciated that particular advantages can be gained from representing content items as rectangular objects with the same axes as for the page. In particular, they have appreciated that considerable computational advantages can be gained while still achieving very effective results. A significant advantage is that it becomes possible to use the mathematics of rectangle dissection—rectangle dissection can be defined as subdivision of a given rectangle by horizontal and vertical line segments into a finite number of non-overlapping rectangles. Cutting a rectangle can be defined as dividing the rectangle into two rectangles by a horizontal or a vertical line. Particular aspects of the invention involve the use of a slicing structure—a slicing structure may be defined as a rectangle dissection that can be obtained by recursively cutting rectangles into smaller rectangles. An example is shown in FIG. 2. Rectangle 20 is divided by a first, horizontal, cut 21 into a rectangle 5 and a remainder rectangle. The remainder rectangle is divided by a second, vertical, cut 22 into a rectangle 4 and a second remainder rectangle. The second remainder rectangle is then divided by a third, horizontal, cut 23 into a rectangle 3 and a third remainder rectangle. Finally, this third remainder rectangle is divided by a fourth, vertical, cut 24 into two rectangles 1, 2.

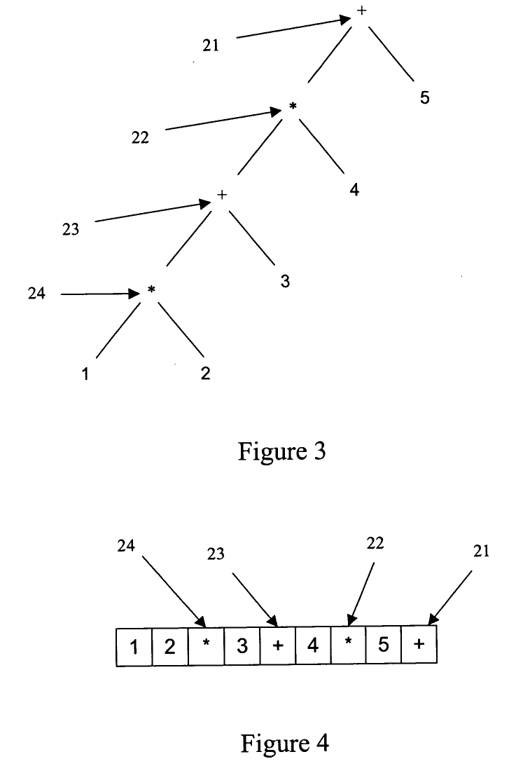

It will be appreciated that a slicing structure can readily be depicted as a binary tree. Such a tree, known as a slicing tree, is shown in FIG. 3. This shows a representation of the slicing structure of FIG. 2, with horizontal cuts 21 and 23 now represented by a horizontal cut operator+and vertical cuts 22 and 24 now represented by a vertical cut operator*.

Wong and Liu (in D. F. Wong and C. L. Liu, “A New Algorithm for Floorplan Design”, Proc. 23^{rd} ACM/IEEE Design Automation Conference, Las Vegas, N.V., 1986, 101-107, the contents of which are incorporated by reference herein) discuss the use of slicing structures to optimise VLSI circuit layout, and have developed a Polish notation for representing slicing structures. Polish notations list operands of functions before (strictly this is reverse Polish) or after their operator—this enables a sequence of operands and operators to be built up which does not require the use of brackets. FIG. 4 shows the slicing tree of FIG. 3 rendered in this Polish notation—the first “root” cut 21 is found at the end of the expression, preceded by the subtree rooted at cut 22 as the first operand and rectangle 5 as the second operand. The remainder of the expression can be seen to describe the rest of the tree according to the same principles. A normalized Polish expression for a slicing structure (in their normalized expressions there are no consecutive operators of the same type) provides a unique representation of a slicing structure.

Cohoon et al (in J. P. Cohoon, S. U. Hegde, W. N. Martin and D. Richards, “Floorplan Design Using Distributed Genetic Algorithms”, IEEE International Conference on Computer Aided-Design 1988, November 198,. IEEE, New York, 452-455, the contents of which are incorporated by reference herein) attempted to solve the VLSI floorplan problem by using genetic algorithms on the slicing structures of Wong and Liu (who used simulated annealing techniques). Unlike simulated annealing (which starts with one candidate expression and then makes a series of allowed changes to it), a genetic algorithm operates on a population of candidate expressions by producing small variations, the results of which (“offspring”) are given a “fitness” score relating to their effectiveness as a solution and which affects the likelihood of their being involved in production of the next generation of candidate expressions.

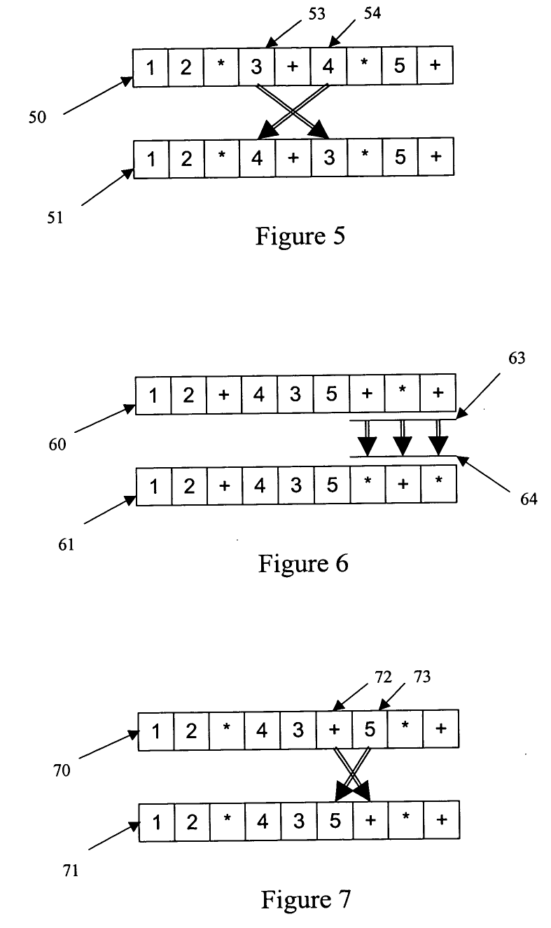

In a preferred embodiment of the present invention, a genetic algorithm is used to find minimised values of a function. Preferred functions will be discussed further below, but the mechanics of the genetic algorithm (which can be used with a multitude of functions) will be discussed first. The different changes that can be used to create offspring will now be discussed with reference to FIGS. 5 to 11.

Change 1—This is shown in FIG. 5. It is a mutation from a single expression 50, and involves the transposition of two adjacent operands 53, 54. If the initial expression 50 is a normalized Polish expression, the mutated expression 51 will also be a normalized Polish expression.

Change 2—This is shown in FIG. 6. This is the second mutation change from a single expression 60, and involves taking the complement 64 of a chain 63 of operators (a sequence of operators uninterrupted by operands), wherein to complement a chain involves transforming every+to a and every * to a+. Again, if the initial expression 60 is a normalized Polish expression, the mutated expression 61 will also be a normalized Polish expression.

Change 3—This is shown in FIG. 7. This is the third mutation change, and involves transposing an adjacent operator 72 and operand 73 in the initial expression 70 to form the mutated expression 71. Unlike Change 1 and Change 2, Change 3 does not necessarily produce a normalized Polish expression—in fact, the mutated expression may not describe a possible slicing structure. The results of Change 3 will therefore need to be checked to ensure that they do describe a slicing structure.

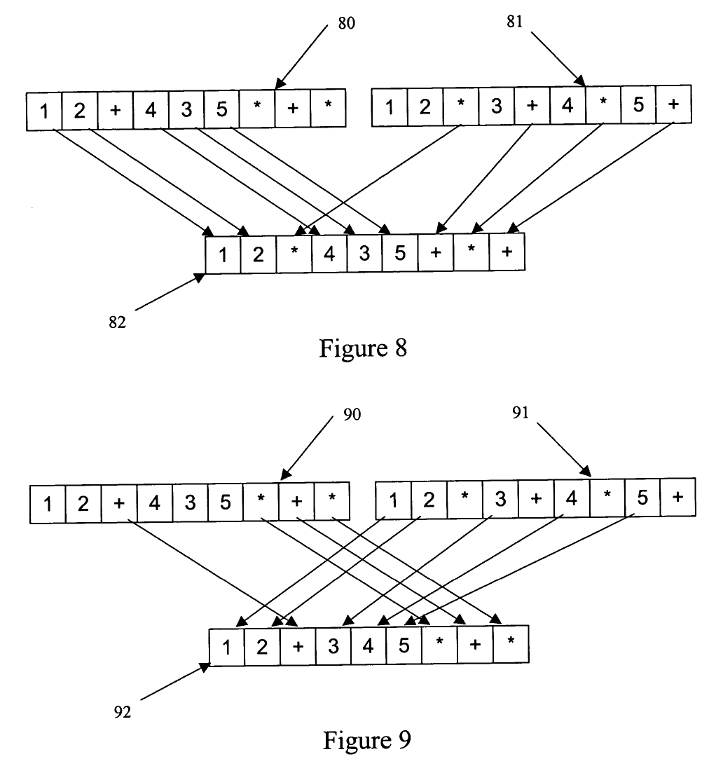

Change 4—This is shown in FIG. 8. This is the first crossover change from two parent expressions, and involves copying the operands from first parent 80 into identical positions in the offspring 82, and then to add operators into the gaps in the same sequence as which they occur in second parent 81. The action of the change is to propagate groups of operands from the first parent to the next generation. The result is a well-formed Polish expression (i.e. it does describe a slicing structure) but not necessarily a normalized Polish expression.

Change 5—This is shown in FIG. 9. This is the second crossover change from two parent expressions, and involves copying the operators from first parent 90 into identical positions in the offspring 92, and then to add operands into the gaps in the same sequence as which they occur in second parent 91. The action of the change is to propagate the slicing of the first parent to the next generation. Again, the result is a well-formed Polish expression but not necessarily a normalized Polish expression.

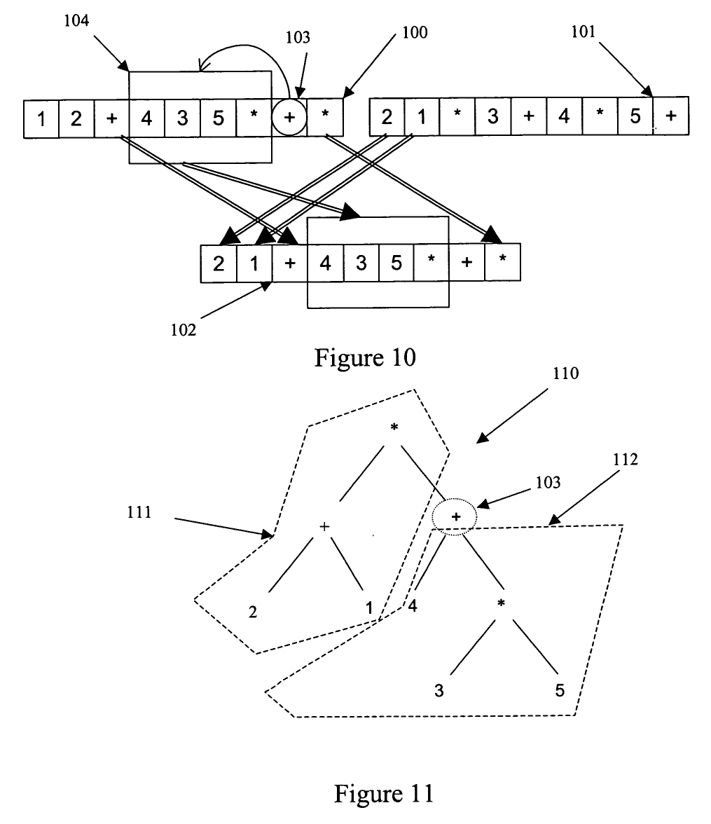

Change 6—This is shown in FIG. 10. This is the third crossover change from two parent expressions, and is more complex than Changes 4 and 5. Initially, the first parent 100 is copied, and then an operator 103 is selected at random. The operands 104 of this operator 103 are preserved, but all other operands in the offspring 102 are then re-ordered using the order in which they appear in the second parent 101. This can be seen more clearly from the slicing tree 110 shown in FIG. 11. A complete subtree 112 is retained from the slicing tree 110 whereas the slicing of the other structure 111 is retained although the operands may be changed. Again, the result is a well-formed Polish expression but not necessarily a normalized Polish expression.

Wong and Liu and Cohoon are both attempting to find VLSI floorplan solutions which meet together minimisation of total area occupied by components and minimisation of wire length between components, and do this by determining a cost function relevant to both objectives which determines whether a given solution is best (or fittest). In Wong and Liu and Cohoon, the components occupy the rectangles of the slicing structure which has a total area A, and the existence, and strength (in that several wires may connect a pair of components) of wires between pairs of components are determined by the nature of the circuit and can be summed to give a total wirelength W. The cost function used by Wong and Liu is

C=A+λW

where λ is a constant which can allow the significance of wiring length to be adjusted with respect to that of total area.

In attempting to solve the problem of page composition, to the present inventors have appreciated that they can use a cost function that relates to one or more properties of an arrangement of objects on a page. The present inventors have realised that, surprisingly, the cost function used for the VLSI floorplan problem by Wong and Liu can be adapted for the page composition problem, particularly when there are several objects to place on to a page and when the objects form two or more groups. The objects take essentially the same role as the components, and the role of the wires can be taken by connections made between objects in the same group. The result of minimising function C now has the effect of minimising a combination of the total area occupied by the objects and of the proximity to each other of objects in the same group. The present inventors have found that this computationally simple approach leads to very effective results. It should however be noted that other cost functions are possible, and that in aspects of the invention an alternative approach to use of the cost function is taken to grouping (and ordering) of elements making it possible for W to be excluded from the cost function. Depending upon the results to be achieved (which may include specific aesthetic criteria with no relation to effective packing), very different cost functions can be used—exemplary properties that can contribute are aspect ratio, whether the centre of mass of the elements is coincident with that of the page, the moment of inertia of the elements, whether elements are located at golden section points (a pure aesthetic criterion) and so on.

A way to create an arrangement in which grouping, if addressed, is addressed by the cost function will now be discussed.

In such an arrangement where grouping is addressed by the cost function “wires” of equal strength are created between each pair of objects in the same group. Minimising “wirelength” thus clearly has the effect of ensuring a close grouping of the group. However, for greater computational simplicity, or to favour a particular arrangement of objects within a group, other arrangements may be made in which objects within a group are connected only to specific other objects within that group (though each group member clearly must be connected to at least one other group member)—ring or star structures thus might be employed, for example.

For the function C to be evaluated for any given arrangement, both total area A and wirelength W must be known. Approaches to calculation of A and W in the context of page composition are discussed below.

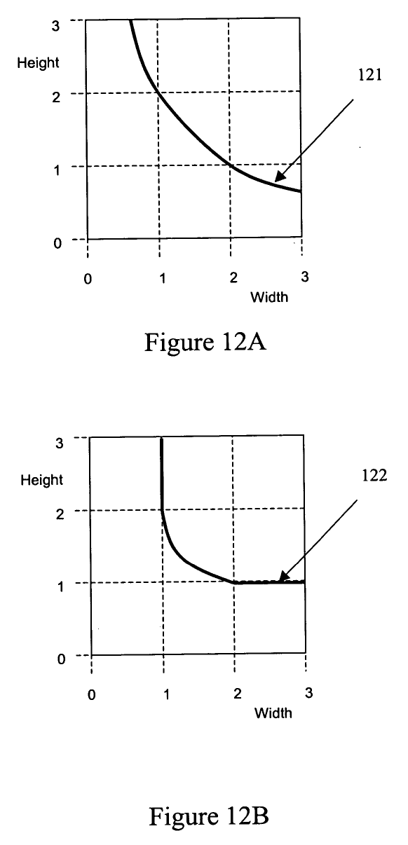

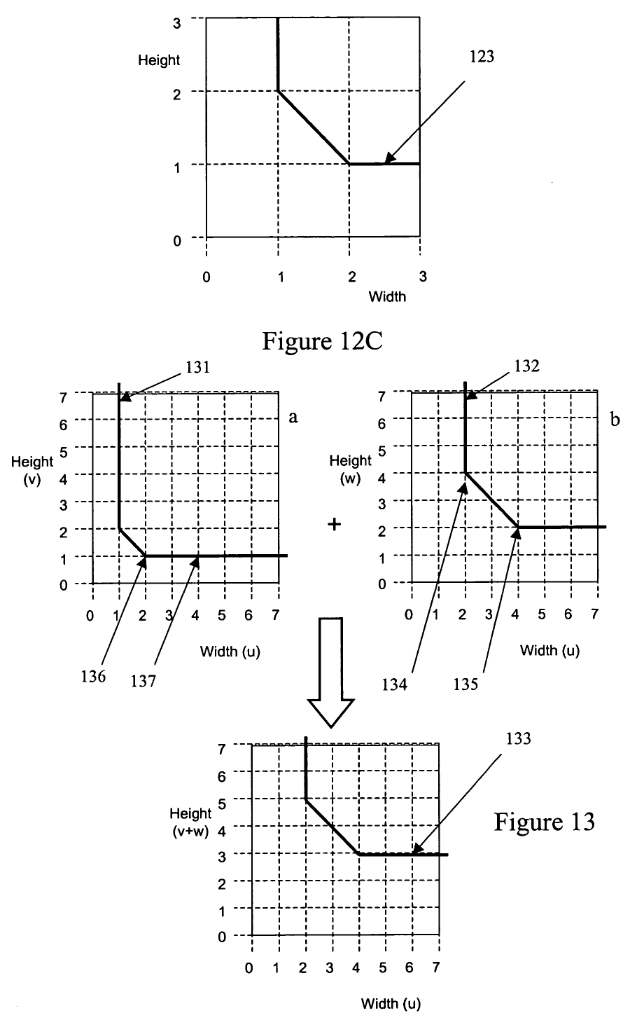

For calculation of area A, the teaching of Wong and Liu can be considered. Where different objects have different aspect ratios, this problem is not trivial, but a solution is indicated in Wong and Liu and will be discussed below with reference to FIGS. 12 and 13. In the initial part of this discussion, objects will be assumed to have constant area but a continuously variable aspect ratio.

For each individual object, a graph can be drawn of width against height, and a bounding curve can be plotted that joins all points of the desired area. This line will be a hyperbola 121, as shown in FIG. 12A. FIG. 12A shows the bounding curve for an unconstrained object of area 2. In practice, there will generally be constraints upon the aspect ratio, and outside upper and lower aspect ratio limits the bounding curve will be a straight line rather than a hyperbola, as increasing one dimension beyond its range will not decrease the other. Such a bounding curve 122 is shown in FIG. 12B—this shows an object with area 2 but with an aspect ratio that can vary between 0.5 and 2.0.

The region above such a bounding curve 122 represents all the possible dimensions of a rectangle that is able to contain the object concerned—any point on the hyperbolic section will be optimal, in that it will contain no wasted space. This is the position for packing of a single object, but complexity is clearly introduced when objects are combined. It is found that the bounding curve for the composite produced by any operator can be derived from the bounding curves of its two operands: if the operator is a vertical cut, then the widths must be added and the greater of the two heights used; whereas if the operator is a horizontal cut, then the heights must be added and the greater of the two widths used. The main computational cost is in adding hyperbolae—however an effective solution can be found by first order approximation of the hyperbolic section to a line, in which case only the end points of the hyperbolic section (which appears as corners) need to be calculated. Such an approximated bounding curve 123 is shown in FIG. 12C.

The use of approximated bounding curves in calculating the bounding curve of a composite is shown in FIG. 13. For the operation ab+, it has already been indicated that the new bounding curve is found by taking the greater of the two widths and the sum of the heights. Where a (bounding curve 131) has area 2 and an aspect ratio of between 0.5 and 2 and b (bounding curve 132) has area 8 and an aspect ratio of between 0.5 and 2, it can be seen that the composite bounding curve 133 can be found by taking the relevant corners 134,135 of b and by adding the height value from the corresponding points 136,137 in a to get the corners of the new bounding curve.

| Corners from b | Corresponding value from a | New corner |
|---|---|---|
| (2, 4) | (2, 1) | (2, 5) |
| (4, 2) | (4, 1) | (4, 3) |

Calculation of the area of an expression is therefore computationally simple. The resulting expression therefore has its own bounding curve, and as all slicing operations are essentially similar and as all approximated bounding curves have the same form, the total area can be calculated very simply by working up from the leaves of the slicing tree to its root, calculating the approximated bounding curve at each node. The total approximated bounding curve yields the lowest area—this will simply be the point on the bounding curve for which xy is minimum.

Wirelength computation is not so mathematically complex—the only significant issue to be resolved is where wires start and finish. A logical choice is the straight line distance (though this is computationally slightly more costly than calculating a corresponding Manhattan distance) between the centres of the rectangular elements—however other choices could be made (a Manhattan distance between element centres, or a straight line distance between element corners, could be employed).

A pseudocode version of the genetic algorithm is as follows:

for G iterations do

for nXC iterations do

select two solutions

crossover those solutions to create offspring

endfor

add all offspring to subpopulation

calculate fitnesses

select a population of n elements by fitness

generate nXM random mutations

endfor

There are n elements in the population, a crossover rate C (with a value between 0 and 1 inclusive) and a mutation rate M (with a value between 0 and 1 inclusive). When a crossover is required, parents are chosen at random each time from the existing population, with the same parent being able to appear in subsequent crossover operations in the same generation, and the crossover operator used is chosen with equal probability from Change 4, Change 5 and Change 6. When selection is made from the generation containing parents and offspring, this selection is probabilistic but with higher probability of selecting elements with higher fitness, this probability difference being a user-variable selection pressure (selection pressure can be made variable, but would generally be kept fixed in a given context). When a mutation occurs, the mutation result replaces the original expression in the population. At the end of a generation, there are still n elements present. Clearly, the algorithm can run through an indefinite number of generations—in the present case, it is chosen to run for G generations, whereas a logical alternative is for it to run until the best solution has not improved for a predetermined number of generations. Population size, crossover rate, mutation rate, selection pressure and wirelength weight (λ) can all in principle be varied by the user.

This genetic algorithm is relatively simple and many variations and enhancements are possible—one possible enhancement is that discussed in Cohoon, of dividing the whole population into several subpopulations, running a genetic algorithm such as that indicated above separately in each subpopulation, and then allowing mixing between the different subpopulations. This process forms an “epoch”, with the compound algorithm being allowed to run over a number of epochs until a termination criterion of the kind indicated above is achieved. Such an approach may increase the diversity that can be achieved and reduce the likelihood of being trapped in a local minimum when a significantly better global minimum is available. The number of subpopulations and the length of an epoch are additional user variables in this arrangement.

The key datum to preserve from running the genetic algorithm is of course the best solution discovered and its total area and wirelength. For diagnostic purposes, it may also be desirable to retain the population at the start and end of a run, the genotypes of each individual in every generation in which a new best solution emerged, the number of generations until the best individual emerged and the highest fitness score in every generation.

It should be noted that although preferred embodiments involve the use of genetic algorithms to calculate an optimal arrangement of objects, aspects of the invention can be performed using other algorithmic approaches. Other iterative approaches appropriate to solving problems of this general type can be used, most obviously simulated annealing. For example, the simulated annealing approach of Wong and Liu, using only operators Change 1, Change 2 and Change 3, could be employed.

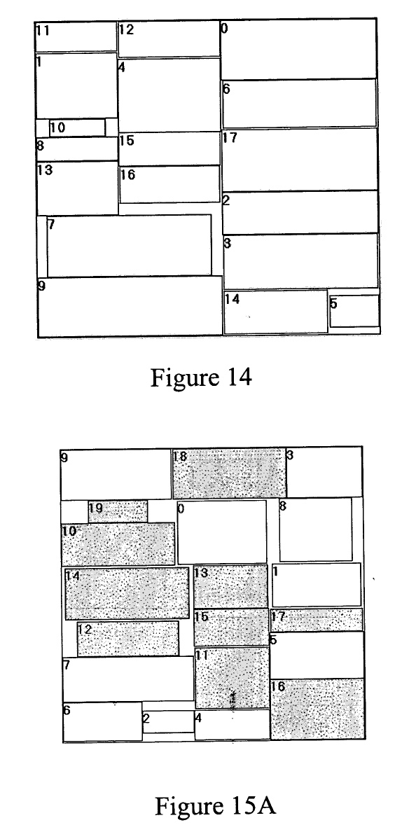

An example of an object layout (without grouping) achieved by the genetic algorithm approach is shown in FIG. 14. It is notable that this layout is visually appealing as well as being spatially compact. One notable feature is that a number of columns (or rows) appear spontaneously—this would appear to be a result of the use of slicing structures, as straight cuts running along groups of objects appear to be favoured.

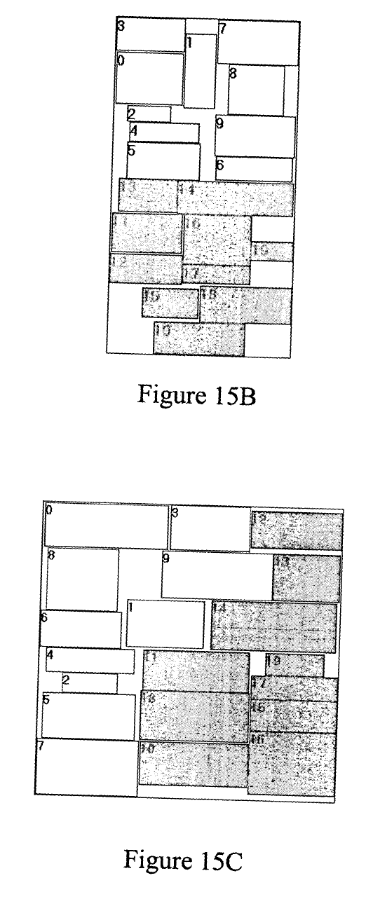

Layouts with grouping are illustrated in FIGS. 15A to 15C, which show arrangements of 20 objects divided into two groups of 10. The type of solution achieved varies considerably with variation in B. FIG. 15A shows a solution with λ=0—unsurprisingly, this has the minimum area (259.9 in relative units) but no apparent grouping. If λ=1, grouping dominates completely and the result is as shown in FIG. 15B, with complete segregation of the two groups but a much larger area of 313.7 and an inconveniently extreme aspect ratio. It is found that in this case a value of λ=0.2 leads to a very effective compromise between grouping and area, shown in FIG. 15C (an area of 267.6 is achieved, less than 3% greater than for the λ=0 solution). It is found that it is significantly easier to achieve a significant compromise between minimum area and grouping when there are only two groups than when there are three or more groups. A preferred solution when three or more groups exist may be to subdivide the page into regions in each of which there will be only two groups of elements.

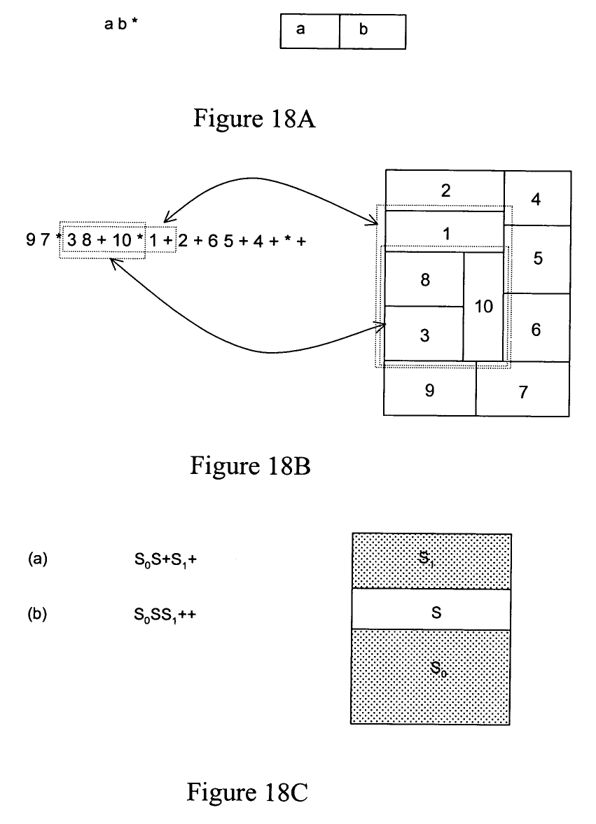

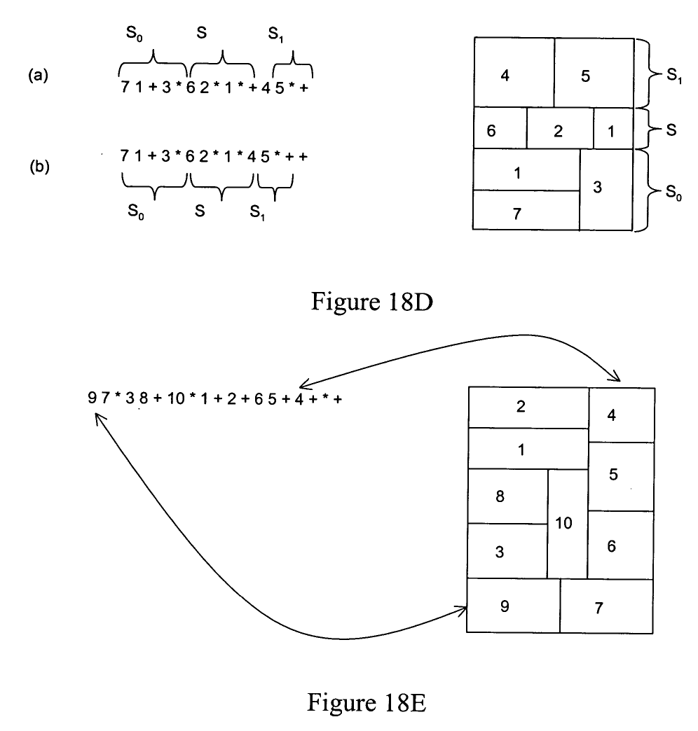

An alternative approach to addressing grouping, and also ordering, will now be described. This approach does not rely on inclusion of a grouping- or ordering-related term into the cost function, but instead by placing constraints upon the slicing structures (in the form of constraints upon the Polish expressions describing the slicing structures). This can be done by using one or more of a number of rules indicating the necessary consequences for a slicing structure of a Polish expression having one or more particular characteristics. A number of such rules are set out below with reference to FIGS. 18A to 18E.

Rule 1: Any pair of operands followed by an operator, i.e. ∘∘?, will share a common, exclusive boundary (by definition). This is shown in FIG. 18A—ab* indicates that a is to the left of a border, b to the right; ab+ would be similar but now a would be below the border with b above, and reversing the operands would clearly only swap the relevant rectangles across the borders concerned.

Rule 2: Any well-formed closed (to be “well-formed” an expression must have at any locus, the number of preceding operands always exceeding the number of preceding operators; to be “closed” a well formed expression must contain n operands and n−1 operators) sequence S within a Polish expression representing a slicing structure will form a rectangle containing only the operands in the sub-expression (this follows from rule1). Such a sequence is hereafter referred to as a WFC sequence. This is shown in FIG. 18B, where “38+10*” forms a WFC sequence within “38+10*1+”, which itself forms a WFC sequence within “97*38+10*1+2+65+4+*+”.

Rule 3: A WFC Sequence S as defined in rule 2 occupies the entire width of the page if S is immediately preceded by a WFC S₀ whose start is at the beginning of the Polish expression describing the slicing structure, and S is immediately followed by the sequence of either (a)+WFC S₁+ or (b) WFC S₁++. In either (a) or (b), the last + must be the end of the Polish expression. In the special case that S₀ or S₁ is of zero length, the leftmost + in (a) or (b) is removed. A complementary case occurs for which S occupies the entire length of the page. FIG. 18C shows the general case slicing structure under this rule, which as can be seen represents both case (a) and case (b). FIG. 18D shows case (a) and case (b) in a case in which all of S, S₀, and S₁ contain more than one element. Again, the same slicing structure is represented by case (a) and case (b).

Rule 4: Again considering a WFC Sequence S as defined in rule 2, it can be noted that the first operand in a WFC sequence always lies at the bottom left of the containing rectangle, whereas the last operand in a WFC sequence always lies at the top right of the containing rectangle.

It should be noted that other rules of this type can be derived either from combining these rules and from the mathematics of slicing structures. For example, it is possible to determine the conditions under which two primitives in a quartet can be guaranteed to be adjacent.

Use of these rules can be used to fix elements, or groups of elements, either absolutely or relatively within a Polish description of a slicing structure in order to achieve results in accordance with the consequences of the different rules. For example, application of Rule 1 would involve a pair of operands being required to be adjacent and followed by an (unspecified) operator. If the operands could be reordered within the pair, this would allow the two elements designated by the operands to be adjacent horizontally or vertically in either possible orientation in each case, but the two elements would be compelled to be adjacent in any allowed slicing structure. Application of Rule 2 would allow reordering within a WFC sequence (according to the rules allowed for reordering of Polish expressions generally) to form another WFC sequence, but would not allow changes to the Polish expression to the whole slicing structure to affect the WFC sequence itself (as far as the whole Polish expression is concerned, the WFC sequence can be considered a single element). Application of Rule 2 thus allows for a powerful grouping constraint—all the elements of a WFC, however reordered, must exist within a bounding rectangle which acts as an element within the main slicing structure. Individual elements can thus be tagged to be part of a group: elements of the group can be reorganised for optimisation within the group, and the group can be moved around in optimisation of an arrangement, but use of the constraint prevents the group from being broken up.

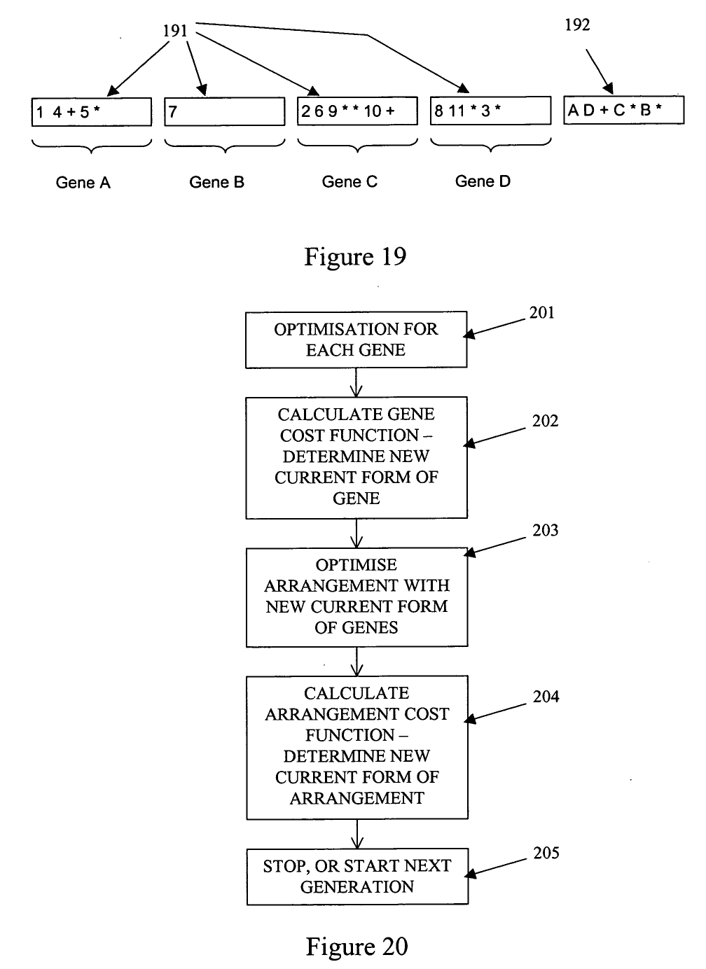

The consequence of constraints such as that provided by use of Rule 2 is to change the practical application, though not the basic nature, of the optimisation process. As shown in FIG. 19, the identification of WFC sequences which can be internally optimised but not otherwise changed within a larger Polish expression amounts to the creation of one or more genes 191 with the Polish expression being rewritten as a modified Polish expression 192 in terms of genes. As each WFC is, essentially, a rectangle, it can be noted that the modified Polish expression 192 describes a slicing structure in essentially the same manner as other Polish expressions shown—it differs only in that some of the operands have further internal structure which is also capable of optimisation. This means that the process of optimisation can (and in preferred arrangements, will) operate on multiple levels—there can be optimisation within a gene, and optimisation of the expression as a whole. If reorganisation within a WFC sequence has no effect on how that WFC sequence would appear within a full arrangement, then optimisation can be achieved simply by running optimisation processes independently within genes and for expressions as a whole (preferably with the same “clock”—though it could be found that different speeds of clock were helpful if it were found empirically or otherwise that better results followed from using a different mutation rate inside and outside the gene), and then calculating the cost function for genes and the whole expression separately and simply adding the result. It is likely, however, that reorganisation of a WFC sequence to form another WFC sequence will have consequences for the arrangement in which the reorganisable WFC sequence forms an element. In this case, the current form of the genes will need to be known at least before calculating the cost function of the arrangement as a whole, and preferably before the optimisation step that leads to calculation of that cost function.

An appropriate set of steps for optimisation of a structure like that shown in FIG. 19 is illustrated in FIG. 20. Firstly an optimisation operation 201 is carried out for each gene (this can simply be the carrying out of a Change operator as indicated above, or can be a longer process involving a repeated process of carrying out Change operations and evaluating the results). After this, or at the end of this if it is an extended process, a form (e.g. a Polish expression) for each gene is determined for that generation and the cost function for each gene (this is the cost function internal to the gene—described below as a gene cost function—relating to factors relating only to the WFC sequence involved in the gene and not to any other parts of the larger slicing structure or to interaction with them or with the slicing structure as a whole) is evaluated in step 202. Next, in step 203, optimisation is carried out on the arrangement as a whole, with each gene in this arrangement “fixed” for that generation in its internal structure. After the optimisation (which may, as before, be a single step or a series of operations and evaluations), the conclusion in step 204 will be determination of an arrangement (which will contain an overall expression with a series of genes and operators, and an internal expression for each gene) and a cost function for that arrangement (which will contain a summation of gene cost functions for each gene together with an overall cost function component relating to the arrangement as a whole, which may include not only components relating to arrangements of genes but possibly also between elements within a gene and elements within other genes). This is the result of optimisation for that optimisation generation: after this, in step 205, the optimisation may conclude if conclusion conditions have been met (number of generations, failure to improve beyond a threshold, etc.) or may continue to another generation as before.

It can be noted that the approach of dividing an expression into a number of genes can be continued within the genes themselves, in principle to the level of the individual components of the genes themselves. There could thus be “sub-genes” within genes, “sub-sub-genes” within sub-genes, and so on. The logical approach to addressing iterative optimisation is, by extension to what is described in FIG. 20, in each generation optimising at the finest scale, then optimising at the next finest scale, and continuing in this fashion until the final step at optimising at the scale of the whole expression (in the form of a number of genes connected by operators).

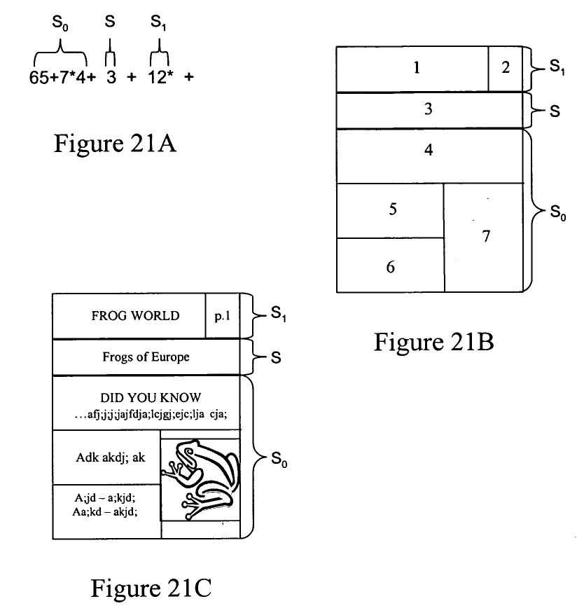

Rule 3 can clearly be used to achieve ordering between different parts of a page by requiring that three WFC sequences remain in the relationship shown by the rule, and this has logical application to headings and subheadings. An arrangement is shown in FIG. 21 in which a page number and title are shown as a top WFC sequence S₁, a heading as a next WFC sequence S, and remaining content as a third WFC sequence S₀. The Polish expression is shown in FIG. 21A, the corresponding slicing structure in FIG. 21B, and the corresponding content is shown in FIG. 21C. As described above with the Rule 2 case, it may be possible here to optimise the WFC sequences independently.

Rule 4 can clearly be used to fix page numbers or page designations stably within a page. For example, by constraining a page number element to be the last operand in a Polish expression, it can be ensured that the page number will be positioned at the top right hand side of the page.

Other rules can clearly be developed with comparable consequences for ordering, grouping, or ordering and grouping combined. However, it can clearly be appreciated from what has been described that recognition and application of rules such as those indicated above can be used in layout techniques employing embodiments of the invention to cope with completely unconstrained tasks (where any element can be moved to any position) through to highly constrained, template-type tasks.

The skilled person will appreciate that many modifications and developments of approaches described above to optimisation of document layout are possible. Various such modifications and developments will be described further below.

Where a composed page is to be displayed in an on-screen window, for example, the aspect ratio of the lowest area solution may not need to be constrained, or may be allowed to vary within wide limits. However, when a composed page is to be printed it may be desirable to constrain the aspect ratio severely. One way to achieve a result with a desired aspect ratio is to choose a different width and height pair on the approximated bounding curve describing the arrangement—instead of choosing the width and height pair that have the lowest product (and hence the lowest total area), the width and height pair can be chosen to fit into the smallest container of the desired aspect ratio (the best solution will now be that with the bounding curve that intersects a line x=ky closest to the origin). Still better results can be achieved by relaxation of the aspect ratio constraints and modifying the cost function to the form

C=A+λW+kP

where P is a penalty term, and k is a user-specified weight. P is calculated as being the difference in area between the layout itself and the smallest rectangle within a specified range of aspect ratios that could contain the layout. This places the compromise between aspect ratio and area minimisation in the hands of the user, if desired.

If a solution results that does not fill a fixed-size page, then a number of choices are available to produce an end result. Clearly one solution is simply to render the result of the iterative calculation (assuming that its bounding rectangle lies within the page dimensions) with as much white space border as is necessary around it, but this will generally not be the most visually attractive solution. A more attractive solution in this circumstance will generally be to add white space according to an appropriate spacing rule, such as adding space evenly between objects—if the aspect ratio of the solution is different from the aspect ratio of the page, a different amount of white space can be added in each dimension. If the aspect ratio has been fixed, a logical solution is to scale the whole solution up or down to fit the page (though this may lead to unsatisfactory differences between, for example, the size of text on different pages). Scaling plus addition of white space is a further possibility. The aesthetic appearance of the result may be further improved by allowing the object to migrate within its rectangle of the slicing structure rather than simply being located centrally within it—this can be done, for example, to align edges or to create white space columns.

In the examples discussed above, the areas of objects have been kept constant and the aspect ratios made continuously variable within broad limits. This may not be a preferred approach for all types of object, and indeed it may be desirable to use different constraints for different types of object. For an image, it may be desirable to have a constant, or near constant, aspect ratio—however, it may be acceptable for the area of the image to vary within broader limits. One way to achieve this might be to derive the bounding curve for such a variable area object using a preferred value (say, halfway between the upper and lower bounds), and then to increase the area of those objects which have ended up with spare space in their constainer. Alternatively, such an object could be allowed to take any value within its range of areas, but a cost term could be added to bias the solution in favour of picking larger images where this was consistent with low overall area and good grouping—an additional cost term proportional to “percentage of area taken up by non-images” could be chosen to have this effect. For text, it may not be appropriate to treat the object as continuously variable in aspect ratio, but for a series of different area solutions to be available at different discrete aspect ratios, according the results of word-wrapping—there is here a danger of substantially increased computational complexity, but useful approximations are available (such as to overestimate the area required by a constant according to font size).

Although page composition has been discussed here as a step independent of selection of objects to be allocated on to a given page, it is reasonable for the allocation step to be informed at least by what can be achieved in the page composition step. The number of items allocated to a page may thus be chosen to lie within the range of optimal effectiveness of the iterative process (typically between 10 and 30 items for the genetic algorithm discussed here—alternatively, if it were desirable to use fewer than 10 items, an alternative calculation process could be used), may be chosen so that items with similar dimensions or aspect ratios are preferably directed to the same page, and that the total area of the objects is less than that of the page but not significantly so.

It will be appreciated that the embodiments described above are exemplary, and that the skilled person may devise embodiments according to aspects of the invention as claimed that differ substantially from the embodiments indicated above.

1. A method of composing a page, or a portion of a page, of a document, by a programmed processor comprises:
receiving a definition of a plurality of objects to be fitted on to the page and dimensional attributes of each of the objects;
establishing an arrangement of the plurality of objects such that each object lies within a separate rectangle of a slicing structure dissection of a rectangular area;
receiving and preparing for evaluation for the plurality of objects a function which provides a total cost of an arrangement of the plurality of objects based on one or more properties of the arrangement; and
finding a slicing structure arrangement of the plurality of objects with a minimised total cost by means of an iterative process.

2. A method as claimed in claim 1, wherein the iterative process comprises repeated application of a genetic algorithm.

3. A method as claimed in claim 2, wherein the genetic algorithm is adapted to generate mutations of existing single arrangements and crossovers between pairs of existing arrangements.

4. A method as claimed in claim 1, wherein one or more of the objects in the plurality of objects are fixed either in absolute position in the arrangement, or in position relative to one or more other objects in the plurality of objects.

5. A method as claimed in claim 1, wherein two or more of the objects in the plurality of objects are grouped together into an object group and are constrained to lie within a group rectangle of a slicing structure dissection.

6. A method as claimed in claim 5, wherein the object group is fixed either in absolute position in the arrangement, or in position relative to one or more other groups or objects in the plurality of objects.

7. A method as claimed in claim 5, wherein the iterative process comprises conducting optimising an arrangement of objects within a group and then optimising an arrangement of any groups and ungrouped objects.

8. A method as claimed in claim 7, wherein the iterative process comprises repeatedly conducting the steps of optimising an arrangement of objects within a group and then optimising an arrangement of any groups and ungrouped objects.

9. A method as claimed in claim 7, wherein the iterative process comprises repeated application of a genetic algorithm.

10. A method as claimed in claim 8, wherein the iterative process comprises repeated application of a genetic algorithm.

11. A method as claimed in claim 6, wherein the iterative process comprises optimising an arrangement of objects within a group and then optimising an arrangement of any groups and ungrouped objects.

12. A method as claimed in claim 11, wherein the iterative process comprises repeatedly conducting the steps of optimising an arrangement of objects within a group and then optimising an arrangement of any groups and ungrouped objects.

13. A method as claimed in claim 11, wherein the iterative process comprises repeated application of a genetic algorithm.

14. A method as claimed in claim 12, wherein the iterative process comprises repeated application of a genetic algorithm.

15. A method as claimed in claim 1, wherein one of the one or more properties of the arrangement is the total area occupied by the arrangement.

16. A method as claimed in claim 1, wherein the plurality of objects form two or more groups, and wherein one of the one or more properties is a measure of the proximity to each other of objects which are members of the same group.

17. A method as claimed in claim 16, wherein the proximity is measured by a total distance of lines joining one group member to another group member, such that every member of a group with more than one member has at least one line joined thereto.

18. A method as claimed in claim 17, wherein each group member is joined by one and only one line to every other member of the same group.

19. A method as claimed in claim 1, wherein one of the one or more properties is the aspect ratio of the arrangement.

20. A data carrier having thereon a computer program adapted to program a processor of a computer system to carry out the following steps:
receiving a definition of a plurality of objects to be fitted on to the page and dimensional attributes of each of the objects;
establishing an arrangement of the plurality of objects such that each object lies within a separate rectangle of a slicing structure dissection of a rectangular area;
preparing for evaluation for the plurality of objects a function which provides a total cost of an arrangement of the plurality of objects based on one or more properties of the arrangement; and
finding a slicing structure arrangement of the plurality of objects with a minimised total cost by means of an iterative process.

21. Computing apparatus comprising a processor programmed to carry out the following steps:
receiving a definition of a plurality of objects to be fitted on to the page and dimensional attributes of each of the objects;
establishing an arrangement of the plurality of objects such that each object lies within a separate rectangle of a slicing structure dissection of a rectangular area;
preparing for evaluation for the plurality of objects a function which provides a total cost of an arrangement of the plurality of objects based on one or more properties of the arrangement; and
finding a slicing structure arrangement of the plurality of objects with a minimised total cost by means of an iterative process.

22. A method of composing a page, or a portion of a page, of a document, by a programmed processor comprising:
receiving a definition of a plurality of objects to be fitted on to the page and dimensional attributes of each of the objects;
establishing, for the plurality of objects, evaluation of a function to represent a total area of an arrangement of the plurality of objects;
minimising the function to find a minimised total area arrangement; and
fitting the minimised total area arrangement to the page.

23. A method as claimed in claim 22, wherein the step of minimising the function is constrained such that the minimised total area arrangement has a similar aspect ratio to the page, and wherein the step of fitting the minimised total area arrangement to the page comprises scaling the minimised total area arrangement.

24. A method as claimed in claim 22, wherein the step of minimising the function is constrained such that no dimension of the minimised total area arrangement is greater than a corresponding dimension of the page, and wherein the step of fitting the minimised total area arrangement to the page comprises separating adjacent objects according to a separation rule.

25. A method as claimed in claim 22, wherein the function depends on the aspect ratio of the arrangement, such that minimisation of the function produces a minimised total area arrangement which is a cooptimisation of total area and of the aspect ratio.

26. A method as claimed in claim 22 wherein minimising the function is carried out by means of an iterative process.

27. A method as claimed in claim 26, wherein the iterative process comprises repeated application of a genetic algorithm.

28. A data carrier having thereon a computer program adapted to program a processor of a computer system to carry out the following steps:
receiving a definition of a plurality of objects to be fitted on to the page and dimensional attributes of each of the objects;
establishing, for the plurality of objects, evaluation of a function to represent a total area of an arrangement of the plurality of objects;
minimising the function to find a minimised total area arrangement; and
fitting the minimised total area arrangement to the page.

29. Computing apparatus comprising a processor programmed to carry out the following steps:
receiving a definition of a plurality of objects to be fitted on to the page and dimensional attributes of each of the objects;
establishing, for the plurality of objects, evaluation of a function to represent a total area of an arrangement of the plurality of objects;
minimising the function to find a minimised total area arrangement; and
fitting the minimised total area arrangement to the page.

30. A method of providing a customised document having a plurality of pages, comprising:
receiving a plurality of selected objects for inclusion in the document from a database of two-dimensional objects and an assignation of each of the selected objects to one of a plurality of groups, and an assignation of each of the selected objects to one of the pages of the document;
producing a function dependent on a total area of the arrangement and on proximity to each other of objects in the same group and for said one of the pages of the document establishing, for the objects assigned to that page, evaluation of the function;
arranging the objects assigned to the said one of the pages in an arrangement such as to minimise the function.

31. A method as claimed in claim 30, wherein the step of arranging the objects comprises dividing the page into regions and making separate arrangements in each of the regions.

32. A method as claimed in claim 30, wherein said step of arranging the objects comprises establishing an arrangement of the plurality of objects such that each object lies within a separate rectangle of a slicing structure dissection of a rectangular area and finding a slicing structure arrangement of the plurality of objects with a minimised total cost by means of an iterative process.

33. A method as claimed in claim 32, wherein the iterative process comprises repeated application of a genetic algorithm.

34. A data carrier having thereon a computer program adapted to program a processor of a computer system to carry out the following steps:
receiving a plurality of selected objects for inclusion in the document from a database of two-dimensional objects and an assignation of each of the selected objects to one of a plurality of groups, and an assignation of each of the selected objects to one of the pages of the document;
producing a function dependent on a total area of the arrangement and on proximity to each other of objects in the same group and for said one of the pages of the document establishing, for the objects assigned to that page, evaluation of the function;
arranging the objects assigned to the said one of the pages in an arrangement such as to minimise the function

35. Computing apparatus comprising a processor programmed to carry out the following steps:
receiving a plurality of selected objects for inclusion in the document from a database of two-dimensional objects and an assignation of each of the selected objects to one of a plurality of groups, and an assignation of each of the selected objects to one of the pages of the document;
producing a function dependent on a total area of the arrangement and on proximity to each other of objects in the same group and for said one of the pages of the document establishing, for the objects assigned to that page, evaluation of the function;
arranging the objects assigned to the said one of the pages in an arrangement such as to minimise the function

36. A method of composing a page, or a portion of a page, of a document, comprising:
defining a plurality of objects to be fitted on to the page and dimensional attributes of each of the objects;
establishing an arrangement of the plurality of objects such that each object lies within a separate rectangle of a slicing structure dissection of a rectangular area;
establishing a function which provides a total cost of an arrangement of the plurality of objects based on one or more properties of the arrangement; and
finding a slicing structure arrangement of the plurality of objects with a minimised total cost by means of an iterative process.
